(19) United States
(12) Patent Application Publication
(10) Pub. No.: US 2011/0253477 A1
(43) Pub. Date: Oct. 20, 2011

(54) Safety Ladder Assembly

(76) Inventor: Steven Martin, Cornwall (GB)

(21) Appl. No.: 13/140,914

(22) PCT Filed: Dec. 21, 2009
(86) PCT No.: PCT/GB09/02927

§ 371 Date: Jun. 20, 2011

(51) Int. Cl. E06C 9/14; E06C 1/56

(52) U.S. Cl. 182/76

(57) ABSTRACT

An escape ladder assembly (20) for mounting adjacent a window opening (4) in a building is provided, the window opening comprising a substantially horizontal window sill (8), the escape ladder assembly comprising a housing (22) for mounting in the wall adjacent the window opening, the housing having an opening in the window sill; a foldable ladder (32); at least one wall engaging fastening means (30) for connecting an end of the foldable ladder to the wall; wherein the foldable ladder is removable from within the housing through the opening in the window sill.

The present invention is directed to an assembly comprising an escape ladder and to a building comprising the same. In particular, the invention is concerned with an assembly wherein the ladder is stored in a storage compartment situated adjacent a window of building.

A variety of assemblies and structures are known for providing means for persons to escape from a building in the case of an emergency, in particular in the case of a fire. Such assemblies and structures are generally required to allow persons to leave a multi-storey building from a floor above the ground floor in situations where the normal routes for leaving the floor and the building are blocked or otherwise impassable. Many buildings incorporate dedicated fire escape assemblies for providing suitable means for exiting in emergency situations. Fire escapes may be provided internally to the building or externally. It is also known to provide assemblies employing a ladder that is stored in a retracted or compact manner, and that may be extended and deployed in an emergency.

U.S. Pat. No. 5,277,271 discloses a fire escape apparatus having a housing that is mounted between structural support studs adjacent a window sill. The housing is provided with an axle structure, around which is wound a rope. In the case of an emergency, the housing may be opened and the rope unwound. The lid of the housing may provide a step, when opened, to allow means for the user to reach the window.

GB 1,188,021 is concerned with a similar apparatus to U.S. Pat. No. 5,277,271 and provides a housing, in which is stored a flexible ladder. The housing is mounted to the wall adjacent a window and may be opened to allow the ladder to be deployed, should an emergency arise. A similar apparatus is disclosed in each of U.S. Pat. No. 5,664,642, GB 2,096,225 and GB 2,297,995.

GB 2,222,848 discloses a similar arrangement, intended for mounting on the external surface of a wall within easy reach of a window. It appears that this assembly may be difficult to deploy by a user reaching out of the window.

The aforementioned assemblies provide a housing and a ladder or other means for use in escaping the building retained within the housing. The housing is intended for fastening to a wall adjacent an opening, either internally or externally. In general, the housing required for such an assembly is a large object, which if located internally may occupy a significant amount of space adjacent the window, in turn restricting the use of the region in the room adjacent the window. This problem appears to be addressed in GB 2,430,462, which discloses an escape ladder stored within a stowage box adapted for location within a wall cavity. GB 2,360,060 also discloses a similar approach, providing an assembly that may be mounted in a cavity in the wall and have a lid that is flush with the surface of the wall, when the housing is closed. An alternative arrangement using the same principle is disclosed in each of GB 2,262,958 and GB 2,292,765.

A particular problem with the aforementioned assemblies is that access is required to the lid of the housing at all times. While the assembly does not require a typically bulky housing or box to be mounted to the interior wall of the building, it does require that the space immediately in front of the assembly cannot be used for other purposes. Otherwise, access to the ladder in the case of an emergency could be prevented.

GB 2,444,499 discloses a particularly complicated arrangement for a flexible ladder to be disposed within a housing in a cavity wall beneath a window. The ladder is removed from the housing through a slot in the windowsill. The ladder includes at its end a cover for closing the slot in the windowsill, the cover being provided with a handle for pulling up and removing the cover from the slot in the sill and deploying the ladder. The ladder is retained within the housing and the rungs of the ladder are arranged to slide in a pair of opposing guides. A fire barrier may also be included, to be deployed with the ladder.

Similarly, WO 2005/010426 discloses a safety ladder assembly in which a ladder may be stored within a housing in a cavity wall. The assembly is shown located below a window, with the housing having an opening at its top extending through the sill of the window. Again, the end of the ladder includes a cover that is pulled upwards and removed from the opening in the sill, to allow the ladder to be deployed.

An alternative arrangement is also disclosed in U.S. Pat. No. 433,061. A ladder assembly is shown having a housing disposed in the cavity in a wall below a window. A flexible ladder is disposed within the housing. The housing has an opening at its top extending through the windowsill, through which the ladder is deployed. The free end of the ladder has a cover attached thereto for closing the slot in the windowsill and for weighting the end of the ladder when the ladder is deployed. The cover is provided with a handle in the surface of the windowsill to aid removing the cover. The cover of U.S. Pat. No. 433,061 has a particularly complicated form that requires a high degree of manipulation to remove the cover from the sill and allow the ladder to be deployed.

It has been found that the aforementioned arrangements relying on a cover set into the sill of the window can be difficult to use. In particular, it can be difficult to lift the cover and deploy the ladder. This is a particular problem, as the ladder assembly would be used in the case of an emergency when the user is most likely under significant stress to deploy the ladder quickly and safely. As a result, there is a need for an assembly that provides an effective means for stowing a flexible ladder, which is easily deployed in the case of an emergency. It would also be an important advantage if the assembly is not at risk from being obscured or obstructed during the normal use of the room in which the assembly is installed.

According to the present invention, there is provided an escape ladder assembly for mounting adjacent a window opening in a building, the window opening comprising an interior sill, the escape ladder assembly comprising:
a housing for mounting in the wall adjacent the window opening, the housing having an opening in the window sill;
a foldable ladder;
at least one wall engaging fastening means for connecting an end of the foldable ladder to the wall;
wherein the foldable ladder is removable from within the housing through the opening in the window sill.

The assembly of the present invention is for installation in a wall adjacent an opening, such as a window or the like, herein referred to as a window opening. The opening has a sill, that is a generally flat, horizontal surface extending along the bottom edge of the opening on the inner side. Such a construction is very typical of many buildings, in particular dwellings such as houses and flats. The assembly of the present invention is thus particularly suitable for use in such buildings. However, the opening will typically have other sill-like surfaces, in particular vertical surfaces on either side of the opening extending from the sill and a further generally horizontal surface at the top of the opening opposite the sill. These surfaces extending generally perpendicular to the inner and outer surfaces of the wall, through the wall and define the opening therein. It is to be understood that the assembly of the present invention may be installed in the wall such that the opening in the housing, as described hereinafter, is one of these other sill-like surfaces around the opening and the term ‘sill’ is to be construed accordingly to include both sills and other sill-like surfaces around an opening.

The assembly comprises a housing that is disposed within the wall adjacent the opening. The housing may be formed from any suitable material. A metal housing, in particular steel, is particularly preferred. The housing may have any suitable shape or configuration, provided that it is suitable to house a flexible ladder in a folded or retracted condition and allows the ladder to be extended from within the housing and otherwise deployed through the window opening to provide a means of escape for persons. In one preferred arrangement, the housing is configured to fit within the confines of a conventional wall, in particular a cavity wall, such as is frequently used in the construction of dwellings, such as houses, flats and the like. Preferably, the housing is of a size and configuration that, when the assembly is installed, the housing does not extend from the wall, in particular internally into the room. Most preferably, the housing is sized to allow it to be fitted so as to be substantially flush with the inner surface of the wall adjacent the opening. A generally rectangular configuration for the housing is preferred.

In one particularly preferred embodiment, the housing is of a size and configuration that it can take the place of a whole number of bricks or blocks used in the construction of the wall adjacent the opening. In particular, the housing may be sized to occupy the space occupied by one, two, three or four blocks used in the wall construction. In this way, the incorporation of the assembly into a wall during construction requires the minimum of changes in design and construction of the wall, in particular avoiding the need to cut and/or otherwise shape blocks to accommodate the assembly. Further, should it be desired to install the assembly into an existing wall, the task is made easier by merely needing to remove a whole number of blocks from the wall, which avoids the need for cutting blocks that are already in situ.

The housing may be provided with a portion that provides a key for plaster or other interior finishing that may be employed in the construction of the room. In particular, the housing may be provided with a mesh on at least a portion of its exterior surface. In such a case, the housing will be disposed within the wall to have the surface having the key, such as mesh, facing outwards, into the room, to facilitate plastering or other finishing.

The housing comprises an opening, through which the foldable ladder held in the housing is removed in the case of an emergency and deployed. The opening is disposed in the housing such that the interior of the housing is accessible by a user through the sill of the window opening. The opening is preferably in the plane of the sill. The opening in the housing is preferably provided with a cover or closure. In particular, the present invention provides an escape ladder assembly for mounting adjacent a window opening in a building, the window opening comprising an interior sill, the escape ladder assembly comprising:
a housing for mounting in the wall adjacent the window opening, the housing having an opening in the window sill, the housing having a cover slidable horizontally between a first position in which the opening in the window sill is closed and a second position in which the opening in the window sill is open;
a foldable ladder;
at least one wall engaging fastening means for connecting an end of the foldable ladder to the wall;
wherein the foldable ladder is removable from within the housing through the opening in the window sill when the cover is in the second position.

The cover of the housing is most preferably disposed in the plane of the sill. In one preferred embodiment, the cover is a portion of the sill or the entire sill, which is removable to open the opening into the housing and allow the ladder to be deployed. The cover is slidable between a first position, in which the cover closes the opening in the housing, and a second position, in which the opening into the housing is open and the ladder may be deployed from within the housing. The cover slides substantially horizontally between the first and second positions. The cover may be arranged to slide in any substantially horizontal direction that allows the user within the room to open the housing and deploy the ladder through the window. For example, the cover may be arranged to slide parallel to the window, that is along the elongate sill. Alternatively, and more preferably, the cover is arranged to slide away from the window, in particular substantially perpendicular to the window. In this way, a user is simply required to pull the cover towards them to reveal the opening into the housing and to be able to reach and deploy the ladder from within.

By having the cover arranged to slide horizontally, it has been found that the housing may be opened more easily by a user, even when items are placed on the window sill, as is commonly the case. The cover may be arranged to slide by any appropriate means. Preferably, the assembly is provided with one or more guides in which the cover is free to slide. In one embodiment, the assembly is provided with a pair of opposing, substantially horizontal guides having a generally C-shaped cross-section, each guide providing a channel along which an edge portion of the cover is free to slide.

In one embodiment, the opening in the housing, once the housing is installed, is covered and closed by a component of the wall, in particular the window sill itself or a portion thereof, which is installed so as to be removable or allowed to open to reveal the opening in the housing. Alternatively, or in addition, the housing is provided with a lid or other closure. The lid or other closure covering the opening in the housing, when the assembly is in place, may be pivoted, for example using hinges, or may be slideable either along the sill or away from the sill, again to reveal the opening and provide access to the interior of the housing.

The assembly comprises a foldable ladder. The term ‘foldable ladder’ as used herein is a reference to any suitable means that may be stored within the housing in a folded or retracted condition and extended or otherwise deployed through the opening to provide a means of egress in an emergency. Preferably, the ladder is a flexible ladder, such as a rope ladder or the like, suitable designs of which are known in the art. The ladder is most preferably formed from fire retardant or fire resistant material.

The assembly further comprises at least one wall engaging fastening means for connecting and end of the ladder to the wall. The fastening means may be any suitable fastening that allows the end of the ladder to be sufficiently well attached to the wall, to allow one or more persons to use the ladder as a means of leaving the building. Suitable fastening means are known in the art. The fastening means preferably attach the end of the ladder directly to the wall. Indirect attachment of the ladder to the wall, for example by having the fastening means attached to the housing, which in turn is securely mounted within the wall may also be used. The fastening means is disposed within the housing and may also serve to secure the housing to the wall. One preferred form of fastening means is one or more O-bolts, that is bolts that comprise a generally circular opening or ‘eye’ at the exposed end when installed. The ladder may be permanently or releasably attached to the fastening means. One preferred means of attaching the ladder to the fastening means is by means of a karabiner, such devices being well known in the art and comprising a loop of metal having a portion forming a sprung gate. The karabiner is most preferably of the design having a lockable gate, in particular a screw-gate.

To allow easier access for persons within the building to reach the opening, the assembly may comprise a second foldable ladder. The second ladder is retained within the housing and attached to the wall in the same manner as the first ladder, as hereinbefore described. While the first ladder is deployed out through the opening in the wall, the second ladder is deployed within the building to provide access to the window opening. Accordingly, the second ladder need only be relatively short, being of a length to reach the floor within the room.

In a further aspect, the present invention provides a building comprising a foldable escape ladder, the building comprising:
a window opening having a substantially horizontal window sill adjacent thereto;
an escape ladder assembly comprising a cavity within which the foldable escape ladder is normally stored, the cavity being disposed in the wall adjacent the window opening and having an opening in the window sill;
at least one wall engaging fastening means connecting an end of the foldable ladder to the wall;
wherein in an emergency, the foldable ladder may be removed from within the cavity through the opening in the window sill and deployed through the window opening to provide an emergency exit for persons within the building.

The ladder assembly is disposed within the cavity within the wall of the building adjacent the opening. The cavity may be formed during the construction of the wall and provided with suitable fastening means for the ladder and for suitable means to cover or close the opening in the cavity, as required. However, most preferably, the building is provided with a cavity in which is disposed a housing and an assembly as hereinbefore described.

As noted above, the ladder assembly preferably comprises a cover for the opening, slidable between the aforementioned first and second positions.

Embodiments of the present invention will now be described having reference to the accompanying drawings, in which:

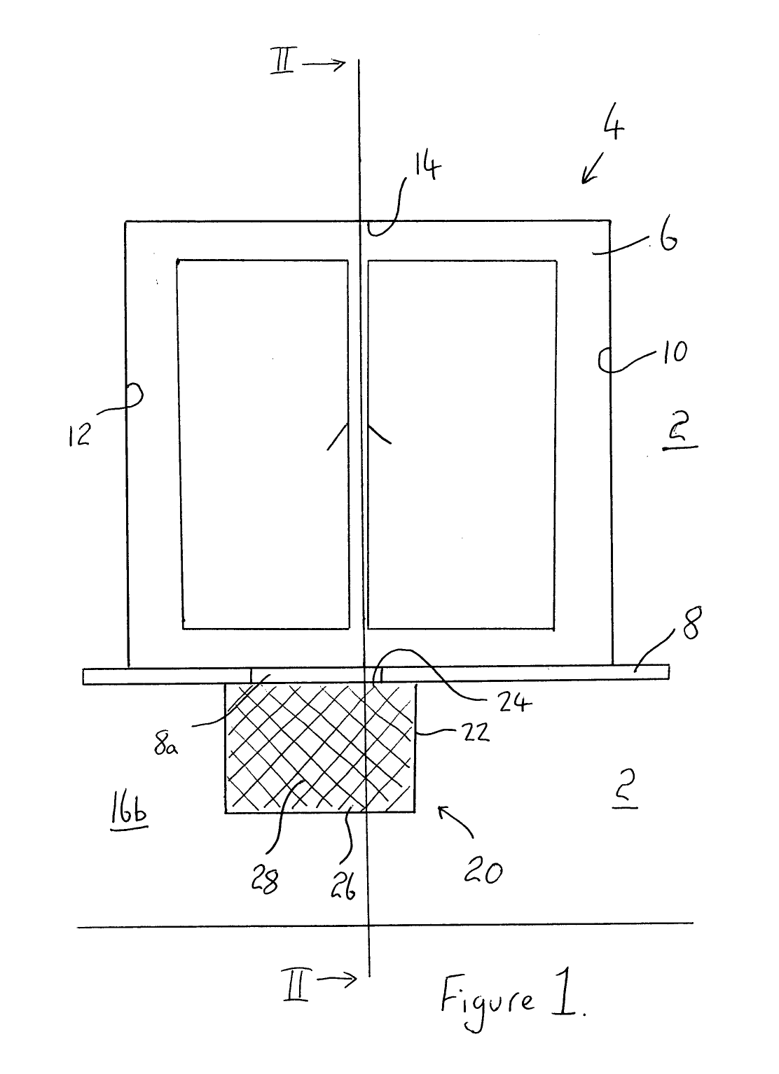

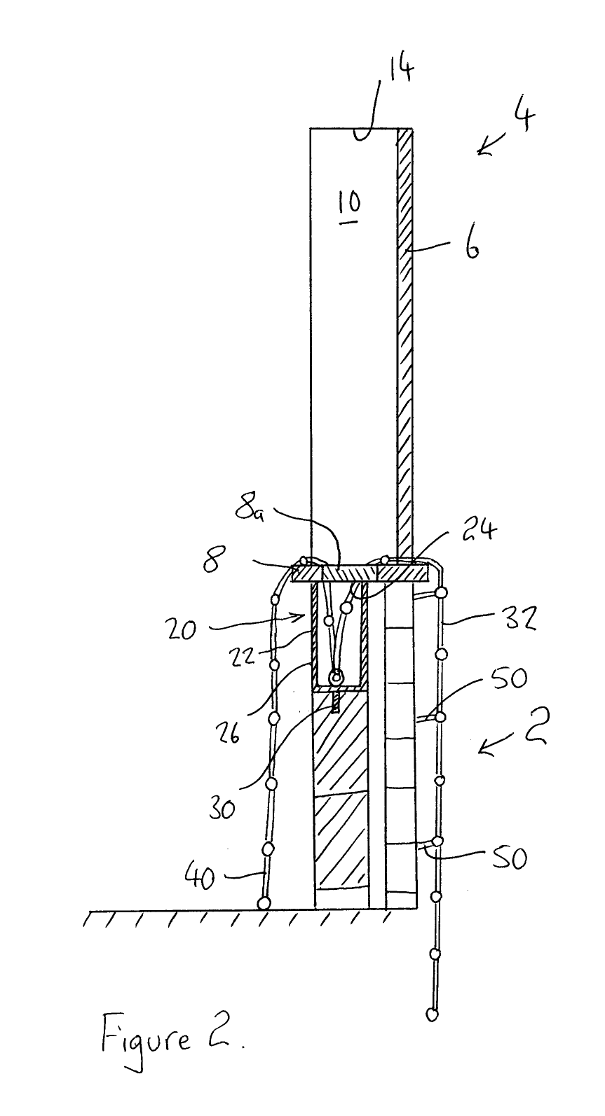

FIG. 1 is a diagrammatic view of a window opening in a wall of a building from within the building, the building comprising an escape assembly according to the general principles of the present invention, with the ladder stowed within the housing;

FIG. 2 is a cross-sectional view of the wall and window opening of FIG. 1 along the line II-II showing a first embodiment of the ladder assembly of the present invention with first and second ladders deployed, as in the case of an emergency;

FIG. 3 is a view of the escape assembly of FIG. 1, showing the interior of the housing in cross-section from the front with the ladder in a stowed position;

FIG. 4 is a cross-section view of the wall and window opening of FIG. 1 along the line II-II showing a second embodiment of the ladder assembly of the present invention with first and second ladders deployed, as in the case of an emergency;

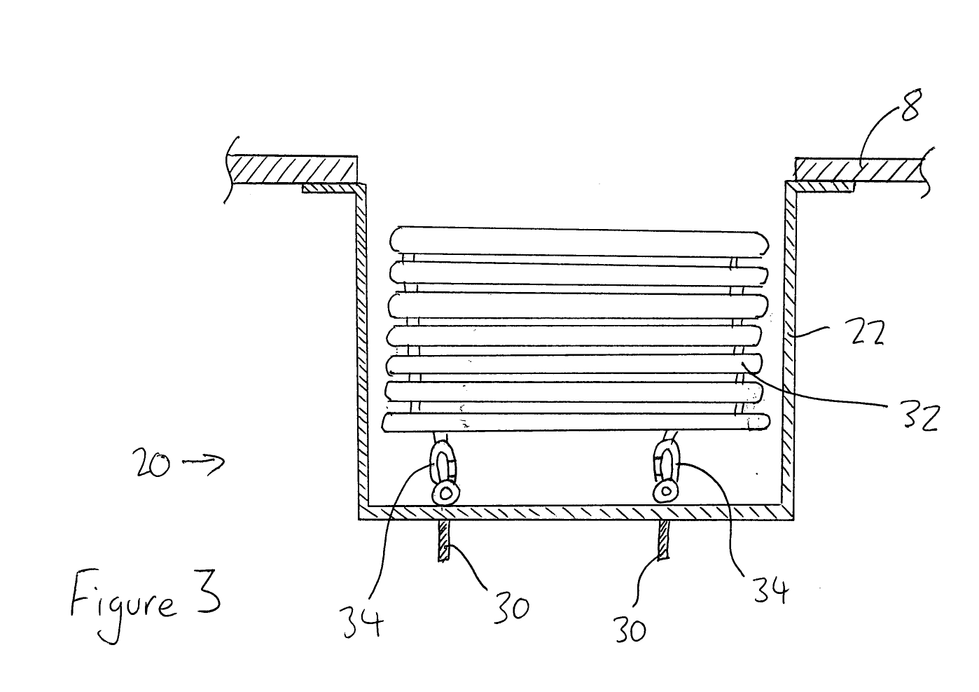

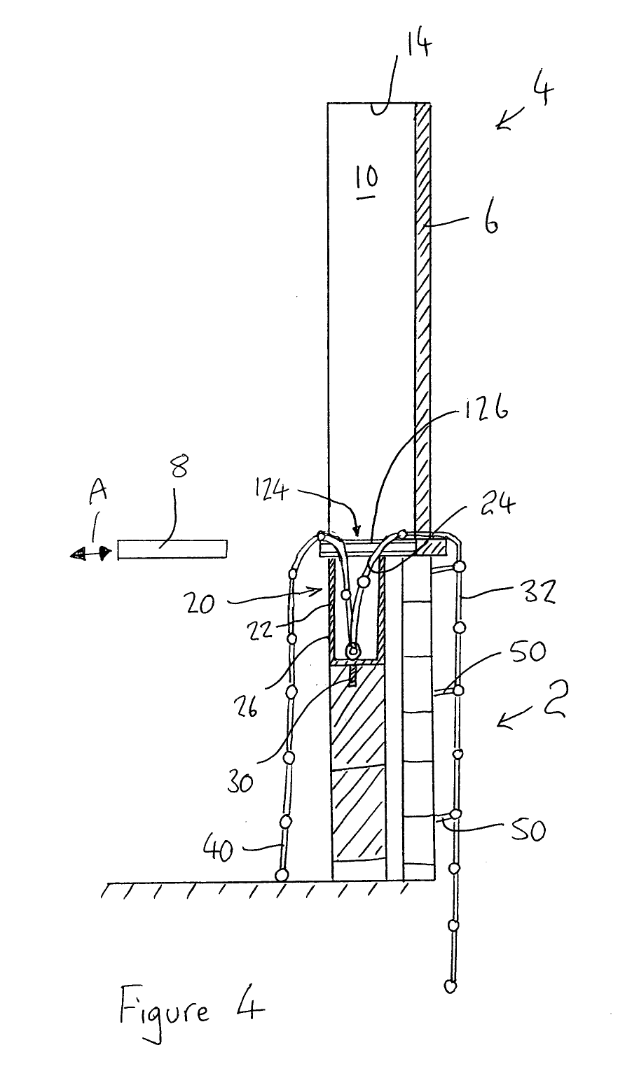

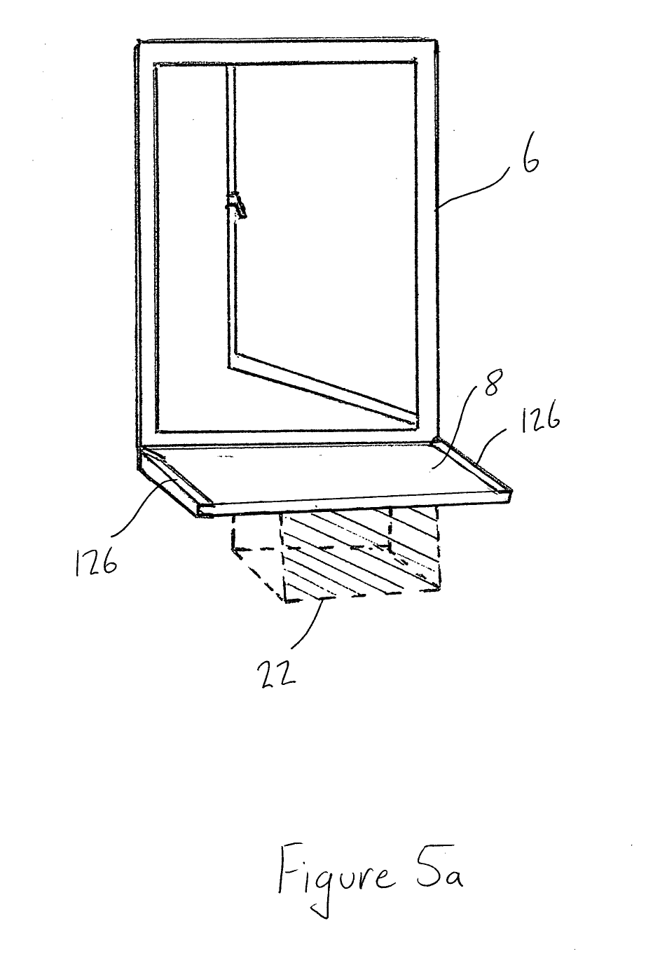

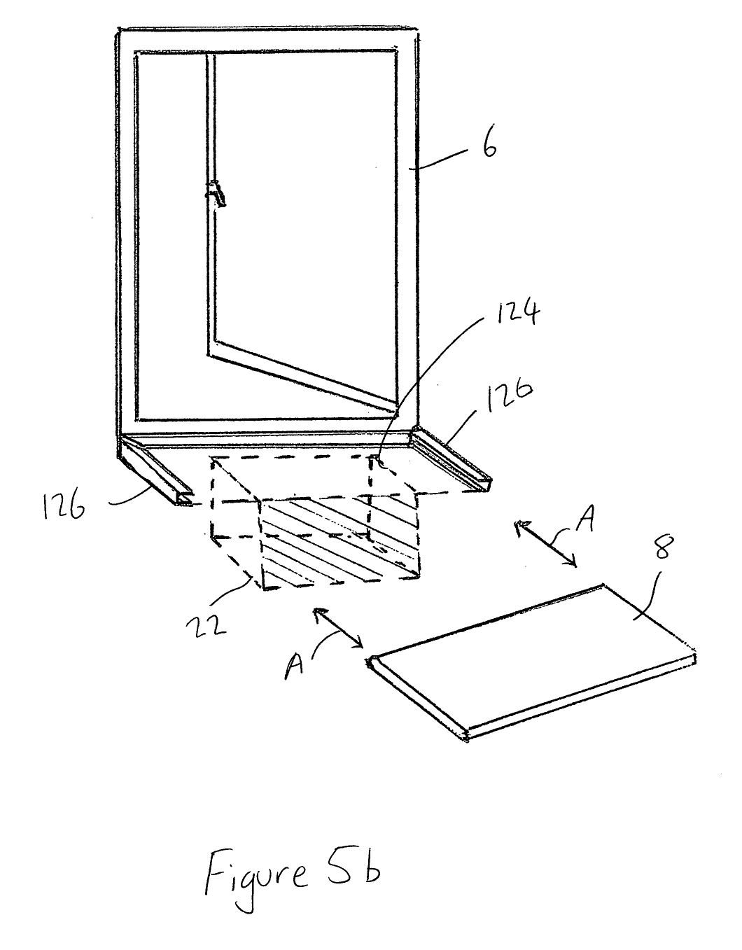

FIG. 5a is a diagrammatical representation of the window and ladder assembly of FIG. 4 showing the operation of the cover of the ladder assembly, with the cover in the first or closed position; and

FIG. 5b is a diagrammatical representation of the window and ladder assembly of FIG. 4 showing the operation of the cover of the ladder assembly, with the cover in the second or open position.

Referring to FIG. 1, there is shown a view of the interior surface of a wall of a building, generally indicated as 2, having a window opening 4 therein. The window opening is provided with a window frame and assembly 6 of generally conventional construction. The window opening comprises a generally horizontal sill 8 extending along the lower edge of the opening 4. Sill-like surfaces 10, 12 extend vertically from the sill 10. A further sill-like surface 14 extends substantially horizontally over the window opening.

The wall 2 is of a generally conventional construction, having an interior wall 16a and an exterior wall 16b separated by a cavity 18.

An escape assembly, generally indicated as 20, is shown disposed in the wall immediately adjacent the window opening 4, more particularly immediately below the sill 8. It is to be understood that the assembly 20 could be mounted in a corresponding position relative to the sill-like surfaces 10, 12, 14 either to one side or above the window opening 4.

The escape assembly 20 comprises a steel housing 22 having a generally rectangular or box-like configuration. The housing 22 is of the same shape and dimensions as a conventional building block, such as used to form the interior wall of a conventional cavity wall, as shown more clearly in FIG. 2. The housing may be larger in size, for example occupy the space of two or three such blocks, as may be required.

The housing 22 has an opening 24 in its upper surface, as viewed in the figures. The housing 22 is mounted in the wall 2 so as to have its outer surface 26 substantially flush with the inner surface of the interior wall 16a. The opening 24 is covered and closed by the sill 8. The sill 8 is provided with a portion 8a that may be moved, for example by being hinged or slideable, so as to reveal the opening 24 and allow access to the interior of the housing 22. Alternatively, or in addition, the housing 22 may be provided with a lid to cover the opening.

As shown in FIG. 1, the outer surface 26 of the housing 22 is provided with wire mesh 28, to provide a key for the surface of the housing to be finished, for example by plastering or rendering, together with the rest of the interior wall 16a.

Fastening means, in the form of eye bolts 30, are mounted into the wall from within the housing 22 and serve to anchor one end of a foldable ladder 32. Under normal circumstances, the foldable ladder 32 is folded and packed within the housing 22. Sufficient eye bolts 30 of suitable size are employed to ensure a secure attachment of the ladder 32 and support one or more persons using the ladder as a means of escaping from the building.

Referring to FIG. 3, the end of the foldable ladder 32 is connected to the eye bolts 30 by means of karabiners 34, of conventional design. The karabiners 34 have a gate that is lockable by way of a threaded sleeve, to ensure that the foldable ladder 32 does become inadvertently detached from the eye bolts, for example when being deployed in an emergency.

The assembly 2 may comprise a second foldable ladder 40, one of which is shown in FIG. 2, but omitted from the other figures for clarity. The second foldable ladder 40 is attached at one end by eye bolts anchored in the wall within the housing 22 and is for deploying within the building to provide easier access to the sill 8 and the window opening 4 for persons seeking to escape.

In the event of an emergency situation requiring persons to leave the building through the window opening 4, the opening 24 in the housing 22 is revealed by moving the portion 8a of the sill 8. The ladder 32 is unfolded and removed from the housing, one end of the ladder 32 remaining attached to the wall by way of the eye bolts 30. The free end of the ladder 32 is deployed through the open window 4 to provide a means of escape. The second ladder 40, if present, is similarly deployed within the room, to provide easier egress from the room, as shown in FIG. 2.

To assist with deploying the foldable ladder 32, the ladder may be provided with members 50 extending from the ladder, for example from each rung or group or rungs. When the ladder is deployed out of the window opening 4, the members 50 bear against the exterior surface of the wall 2 and keep the ladder spaced from the wall, thus easing the use of the ladder by persons descending.

Referring to FIG. 4, there is shown a cross-section view of the wall of FIG. 1 with an alternative embodiment of the ladder assembly of the present invention. The components of the embodiment shown in FIG. 4 common to those of the embodiment of FIG. 2 are indicated using the same reference numerals, details of which are as hereinbefore described. The characteristic features of the ladder assembly of the embodiment of FIG. 4 are as follows:

The housing 22 has an opening 124 in its upper region, the opening 124 extending through the sill 8 of the window. The sill 8 forms a cover for the opening 124 in the housing. At each lateral end of the opening 124 there is provided a guide 126, in the form of a C-shaped channel in which the edge portion of the sill 8 is held and free to slide horizontally perpendicular to the window frame 6. In FIG. 4, the sill 8 is shown in the second position, that is having been slid away from the window frame 6, and the ladders are deployed through the opening 124 in the top of the housing 22. In the embodiment shown, the entire sill 8 is removable as indicated to open the housing and allow the ladders to be deployed from within the housing. Alternatively, the cover of the opening 124 may be smaller and form a portion of the sill. In this case, the guides 126 are mounted on each end of the opening to the edges of the fixed portions of the sill. The assembly is shown with two ladders, one ladder 32 for deploying through the window to the outside of the building 4, and the second, shorter ladder 40 for deploying within the building to aid a person reaching the open window. The second ladder 40 may be omitted, if required or appropriate.

The operation of the sill 8 as a cover to the opening 124 in the housing 22 is shown diagrammatically in FIGS. 5a and 5b. As shown in FIG. 5a, with the sill 8 in a first position, the sill is located between the opposing guides 126 and covers the opening 124 in the housing 22 (shown in dotted lines) within the cavity of the wall. In the case of an emergency, such as a fire, and the sill 8 is slid in a horizontal direction inwards and away from the window frame 6 into the second position, shown in FIG. 5b, in which the opening 124 in the top of the housing 22 is revealed and the ladders within available to be deployed through the opening.

1-16. (canceled)

17. An escape ladder assembly for mounting adjacent a window opening in a building, the window opening comprising an interior sill, the escape ladder assembly comprising:
a housing for mounting in the wall adjacent the window opening, the housing having an opening in the window sill, the housing having a cover slidable horizontally between a first position in which the opening in the window sill is closed and a second position in which the opening in the window sill is open;
a foldable ladder;
at least one wall engaging fastening means for connecting an end of the foldable ladder to the wall;
wherein the foldable ladder is removable from within the housing through the opening in the window sill when the cover is in the second position.

18. An escape ladder assembly according to claim 1, wherein the housing is made of steel.

19. An escape ladder assembly according to claim 1, wherein the housing comprises wire mesh.

20. An escape ladder assembly according to claim 3, wherein the wire mesh is disposed so as to face the interior surface of the wall adjacent the window opening, when the assembly is installed.

21. An escape ladder assembly according to claim 1, wherein the cover of the housing is formed from at least a portion of the sill.

22. An escape ladder assembly according to claim 5, wherein the cover is formed from the entire sill.

23. An escape ladder assembly according to claim 1, further comprising a guide means within which the cover is mounted so as to slide between the first and second positions.

24. An escape ladder assembly according to claim 7, wherein the guide means comprises a pair of opposing, substantially C-shaped guide rails disposed at opposite ends of the opening, each guide rail engaging a respective edge portion of the cover.

25. An escape ladder assembly according to claim 1, wherein the housing is of a size so as to replace one or more standard building blocks within the wall adjacent the window opening.

26. An escape ladder assembly according to claim 1, wherein the wall engaging fastening means fastens the ladder directly to the wall in which the assembly is installed.

27. An escape ladder assembly according to claim 10, wherein the wall engaging fastening means comprises one or more O-bolts.

28. An escape ladder assembly according to claim 11, wherein the ladder is releasably secured to the O-bolt, preferably using a karabiner.

29. An escape ladder assembly according to claim 1, further comprising a second ladder of a length suitable to be deployed within the building to provide easier access to the window opening.

30. An escape ladder assembly according to claim 1, wherein the ladder comprises members extending therefrom which, when the ladder is deployed, keep the ladder spaced from the exterior surface of the building.

31. A building comprising a foldable escape ladder, the building comprising:
a window opening having a substantially horizontal window sill adjacent thereto;
an escape ladder assembly comprising a cavity within which the foldable escape ladder is normally stored, the cavity being disposed in the wall adjacent the window opening and having an opening in the window sill;
at least one wall engaging fastening means connecting an end of the foldable ladder to the wall;
wherein in an emergency, the foldable ladder may be removed from within the cavity through the opening in the window sill and deployed through the window opening to provide an emergency exit for persons within the building;
the escape ladder assembly further comprising a cover for the opening in the window sill, the cover being slidable substantially horizontally between a first position in which the cover extends across and closes the opening and a second position in which the opening is open and allows the foldable ladder to be deployed from within the housing.
